(19) United States
(12) Patent Application Publication
(10) Pub. No.: US 2006/0092027 A1
(43) Pub. Date: May 4, 2006

(54) Identification tag, method of its attachment, and container with identification tag attached

(76) Inventor: Mayumi Ito, Kyoto (JP)

Correspondence Address: DICKSTEIN SHAPIRO MORIN & OSHINSKY LLP, 2101 L Street, NW, Washington, DC, 20037, US

(21) Appl. No.: 11/226,401

(22) Filed: Sep. 15, 2005

(30) Foreign Application Priority Data
Sep. 15, 2004 (JP) 2004-267815

(51) Int. Cl. G08B 13/14; G06F 17/00; G06K 19/06

(52) U.S. Cl. 340/572.7; 235/492; 235/375

(57) ABSTRACT

A wireless IC tag attached to the object in the tangential direction to open up a space between the two, the structure of the tag 41 is such that wireless IC tag 1 is sandwiched between thin rectangular strips of plastic etc., which even when bent in the lengthwise direction, will return to their original shape. Tag area 42, where wireless IC tag 1 is sandwiched, is of a different color than support area 43 to allow for clear visual discrimination of its position. Support area 43 is designed to secure distance between object 2 and wireless IC tag 1. The end opposite the foregoing thin slip tag area 42 is attachment area 45 which is supported in a manner that allows it to freely rotate around pin 44. Attachment area 45 can retain the tag area 42 and support area 43 at any desired angle. Attachment area 45 is attached to object 2 by paste, glue, clips, pins, etc., or, it may be inserted into the object. The present invention relates to non-contact communication system.

### BACKGROUND OF THE INVENTION

1. Field of the Invention

The present invention relates to an identification tag, method of its attachment and to a container with an identification tag attached, for example it preferably relates to identification tags, methods of their attachment and to containers with identification tags attached wherein identification information for the object to which it is attached can be read through non-contact means.

2. Discussion of Background Technology

Technology existed in the prior art for the non-contact reading of information recorded on a recording medium comprised of a semiconductor, etc., such as that described in Japanese Publication No. 2003-187196.

On automobile assembly lines, for example, a recording medium is attached to parts being conveyed, to parts subject to intermediate processing steps, or to pallets, which identifies the type of part or product, instructions for robotic processing, etc. Thus, information from the recording medium is read at each point on the processing line to provide instructions to the worker or robot performing the operation.

Another example is the use of such recording mediums in department stores and super markets where information related to the type of merchandise and the price can be read from the recording medium and used to keep track of warehoused stocks. Hereinafter, the parts, merchandise, etc. to which such recorded media can be attached shall be referred to as “objects.” Also, the electronic circuit on recording medium attached to the object onto which the information that has been written that can be wirelessly communicated shall be referred to as a “wireless IC (integrated circuit) tag.”

FIG. 1 shows an example of a system that can read the information recorded on the recording medium composed of a semiconductor, etc. in a non-contact manner (hereinafter referred to as a “non-contact communication system”). In this system, a plurality of objects 2 to which the wireless IC tags 1 are continuously provided are made to pass by the communication device 3 at a prescribed distance.

In response to a request from communications device 3, information related to object 2 that is retained in memory 12 (FIG. 2) of the wireless IC tag 1 is transmitted from loop antenna 14 (FIG. 2).

Communication device 3 requests the transmission of information memorized in wireless IC tag 1, and in response to the transmitted information thereby supplied, receives that information.

FIG. 2 shows an example of the configuration of the wireless IC tag 1. The respective units in wireless IC tag 1 are controlled by means of control unit 11 executing a control program stored in memory 12. Further, control unit 11 reads information stored in memory 12 and outputs it to the modulation unit 13. The memory 12, based upon the execution of a program by the control unit 11, holds information related to object 2 to which said wireless IC tag 1 is attached.

Modulation unit 13, under control of control unit 11, modulates, using a specific modulation method, the information (information related to object 2) that was input from control unit 11 into memory 12 and the resulting transmission signal is output from loop antenna 14. Loop antenna 14, transmits the transmission signal input from modulation unit 13 as an electromagnetic wave. Also, loop antenna 14 receives signals sent from communication device 3 and outputs them to demodulation unit 15. Demodulation unit 15 demodulates the signal input from loop antenna 14 and then output the resulting received signal into control unit 11. Power generation unit 16 generates electric power based on the current resulting from the electromagnetic waves transmitted from communications device 3 and electromagnetic induction from loop antenna 14, which is then supplied via control unit 11 to the respective other units of wireless IC tag 1.

### SUMMARY OF THE INVENTION

### Problems To Be Resolved by the Present Invention

However, the characteristics of wireless IC tag 1 dictate that should the object 2 to which it is attached be metal or have significant content of an aqueous substance (e.g. plant or animal products, plastic bottles containing drinks, etc.), interference in the electromagnetic waves comprising the transmitted and received signal by the metal or aqueous contents impedes normal communications processes.

As shown by the sectional view of FIG. 3, the prior art attempted to prevent interference from metal by distancing the surface of object 2 in the normal line direction from wireless IC tag 1, and in addition, it erected a layer of a substance inhibitive to interference (e.g. ferrite layer 21 shown it FIG. 3).

Yet measures such as establishing a ferrite layer 21 resulted in increased costs.

Furthermore, no simple method was found in the prior art to inhibit the interference caused by aqueous substances.

Further, the conventional countermeasure, isolating object 2 from wireless IC tag 1, as shown in FIG. 3, was only conceived as “isolating wireless IC tag 1 from the surface of object 2 in the direction of the normal line.” There was, however, no invention based on the concept of “isolating wireless IC tag 1 from the surface of object 2 along a tangential line” which could be called a conceptual blind spot.

The present invention was conceived after reflecting upon the above described state of affairs, and involves attaching the wireless IC tag to the object in the tangential direction to open up a space between the two.

Means Used To Resolve Problems

An Identification tag according to the present invention includes 1) a communication means to communicate information related to an object in a non-contact manner, and 2) an isolation means by which isolation between the object and the communication means is provided in the tangential direction with respect to the surface of the object, maintaining the correspondence between the communication means and the object, while the communication means is supported on one lengthwise end of the isolation means, and the object is attached or connected on another lengthwise end of the isolation means.

In identification tag according to the present invention, the isolation means isolates the object from the communication means in the tangential direction with respect to the surface of the object.

Accordingly, should the object be a metal, or even if it should contain an aqueous substance, it is possible to inhibit any interference in communication.

The communication means may comprise, for example, a wireless IC tag.

The isolation means may comprise, for example, a slip of paper or plastic.

The foregoing isolation means may include a support means to support the communications means and an attachment means to attach the communications means to the object.

The support means and attachment means of the isolation means may be made distinguishable from each other either by color or shape.

Accordingly, this makes it possible for the user to clearly visualize the position of the support means that supports the communication means.

Further, the foregoing isolation means includes a rotary support means to connect the support means and the attachment means so that said support means is adjustable at any desired angle as an axis to which the attachment means can be attached.

Accordingly, this makes it possible to set the angle of the support means, which supports the communication means, to an orientation more appropriate for communications.

It is further possible to equip the other end of the foregoing attachment means with a ring-shaped elastic member.

So doing facilitates the attachment of the identification tag to an object of any desired shape with an irregular surface. Further, the identification tag may be easily removed.

The foregoing ring-shaped elastic member may be comprised, for example, of a rubber band.

The foregoing isolation means may be made from material that can recover its original shape after being bent.

Accordingly, this protects the identification tags from being damaged should any of the objects bearing the identification tags be stacked.

The method of attachment of this invention comprises the step of isolating a communication means from an object in the tangential direction with respect to the surface of the object by the isolation means, maintaining the correspondence between the communication means and the object, while the isolation means supports the communication means on one lengthwise end of the isolation means, and supports the object on another lengthwise end of the isolation means.

The method of attachment in the present invention supports the communication means on one of its lengthwise ends, and attaches it to the object on the other end.

This makes it possible to isolate the communication means from the object in the tangential direction with respect to the surface of the object.

A container with an attached identification tag according to the present invention includes 1) a communication means to communicate information related to the container in a non-contact manner, and 2) an isolation means by which isolation between the container and the communication means is provided in the tangential direction with respect to the surface of the container, maintaining the correspondence between the communication means and the container, while the communication means is supported on one lengthwise end of the isolation means, and the object is attached or connected on another lengthwise end of the isolation means.

The isolation means in the container with identification tag attached according to this invention makes it possible for the communication means to be isolated from the container with identification tag attached in the tangential direction with respect to the surface of the container with identification tag attached.

Accordingly, it is possible to prevent interference in communications even if the container with identification tag attached is made of metal, or contains an aqueous substance.

### Effects of the Invention

The present invention also makes it possible to distance the wireless IC tag in the tangential direction from the surface of the object.

### A BRIEF EXPLANATION OF THE DRAWINGS

FIG. 1 is a structural configuration of a non-contact communications system.

FIG. 2 is a block diagram structural example of the wireless IC tag shown in FIG. 1.

FIG. 3 is a conceptual drawing to facilitate explanation of conventional technology to prevent communications interference.

FIG. 4 is an external view of a slip type tag according to the first embodiment of the present invention.

FIG. 5 is an external view of a slip type tag according to the second embodiment of the present invention.

FIG. 6 is an external view of a slip type tag according to the second embodiment of the present invention.

FIG. 7 is an external view of a slip type tag according to the third embodiment of the present invention.

FIG. 8 is an external view of a slip type tag according to the fourth embodiment of the present invention.

FIG. 9 is an external view of a thin tag according to the fifth embodiment of the present invention.

FIG. 10 is an external view of a thin tag according to the sixth embodiment of the present invention.

FIG. 11 is an external view of a thin tag according to the sixth embodiment of the present invention.

FIG. 12 is an external view of a thin tag according to the seventh embodiment of the present invention.

FIG. 13 is an external view of a thin tag according to the eighth embodiment of the present invention.

FIG. 14 is an external view of a three dimensional tag according to the ninth embodiment of the present invention.

FIG. 15 is an external view of a marker pin type tag according to the tenth embodiment of the present invention.

FIG. 16 is a sample external view of the slip type tag attached to an object.

FIG. 17 is a sample external view of the slip type tag attached to an object.

FIG. 18 is a sample external view of the slip type tag attached to an object.

FIG. 19 is a sample external view of the object to which the thin tag is attached.

### DESCRIPTION OF THE PREFERRED EMBODIMENTS OF THE INVENTION

Embodiments of the present invention will be described below where specific examples will be given with regard to the structural requirements described in the Claims and the embodiments of the implementation of the invention corresponding thereto. The specific examples used in this description support the inventions described in the claims, and are specified to confirm the implementation of various forms of the invention. Accordingly, while implementation embodiments of the invention will be described, even if there should be other specific examples not described here that correspond to the structural requirements, that fact and those specific examples should not be understood as not conforming to the structural requirements. Conversely, if a specific example corresponding to the structural requirement is described herein, that does not mean that fact and those specific examples do not correspond to structural conditions other than those structural requirements set forth.

Furthermore, in this description of forms of implementation embodiments of this invention, does not mean that all such inventions have been covered in all claims. In other words, in this description, should the described form of an implementation embodiment correspond to an invention, that does not deny the existence of inventions not described in the claims of this application, to wit, the inventions may be divided, corrected or added to in the future.

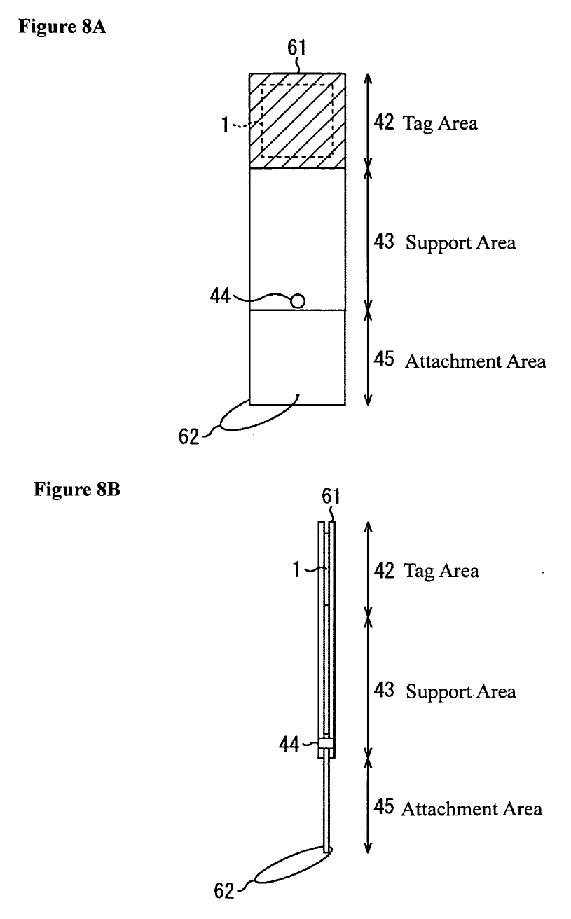

The identification tag according to claim 1 (for example the slip type tag 61 shown in FIG. 8) includes a communication means (for example, the wireless IC tag 1 of FIG. 2) that can communicate information related to an object in a non-contact manner, and an isolation means (for example by tag area 42, support area 43, and attachment area 45 in FIG. 8) by which isolation between the object and the communication means is provided in the tangential direction with respect to the surface of the object, while the communication means is supported on one lengthwise end of the isolation means, and the object is attached or connected on another lengthwise end of the isolation means.

The isolation means of claim 2 includes a support means (for example tag area 42 in FIG. 8) that supports the communication means, and an attachment means (for example, support area 43 and attachment area 45 in FIG. 8) to attach the tag to the object.

The isolation means of claim 4 includes a rotary support means (for example pin 44 in FIG. 8) that connects the support means to the attachment means, wherein the support means uses the rotary support means as an axis around which it can be set at any desired angle with respect to the attachment means.

The attachment means of claim 5 is equipped with a ring shaped elastic member on the other end (for example the attachment band 62).

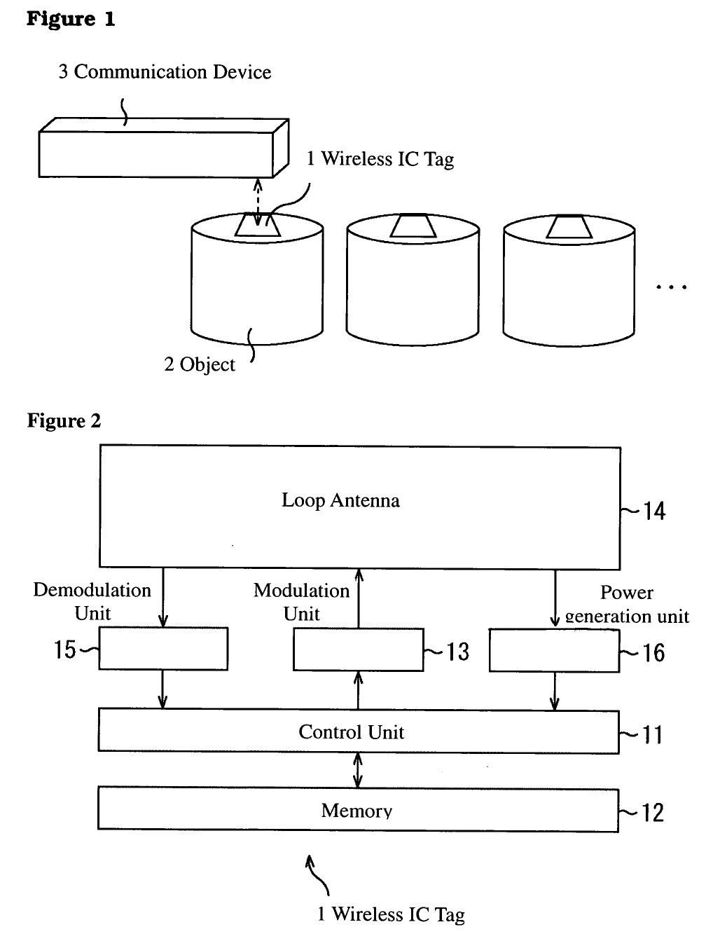

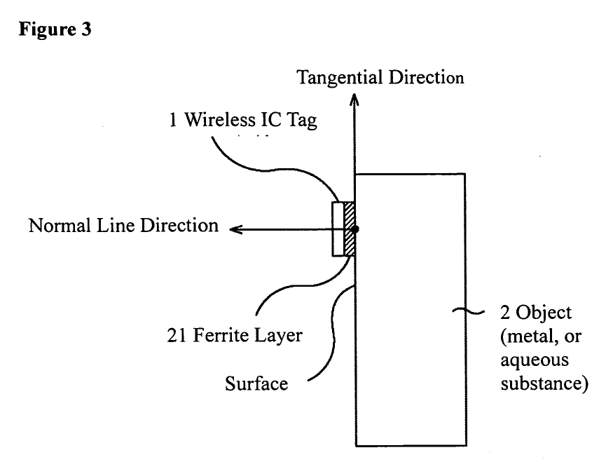

The method of attachment described in claim 7 includes a step of isolating a communication means (for example, the wireless IC tag in FIG. 1) from an object in the tangential direction with respect to the surface of the object by the isolation means (for example the tag area 42, support area 43 and attachment area 4 in FIG. 8), while the isolation means supports the communication means on one lengthwise end of the isolation means, and supports the object on another lengthwise end of the isolation means.

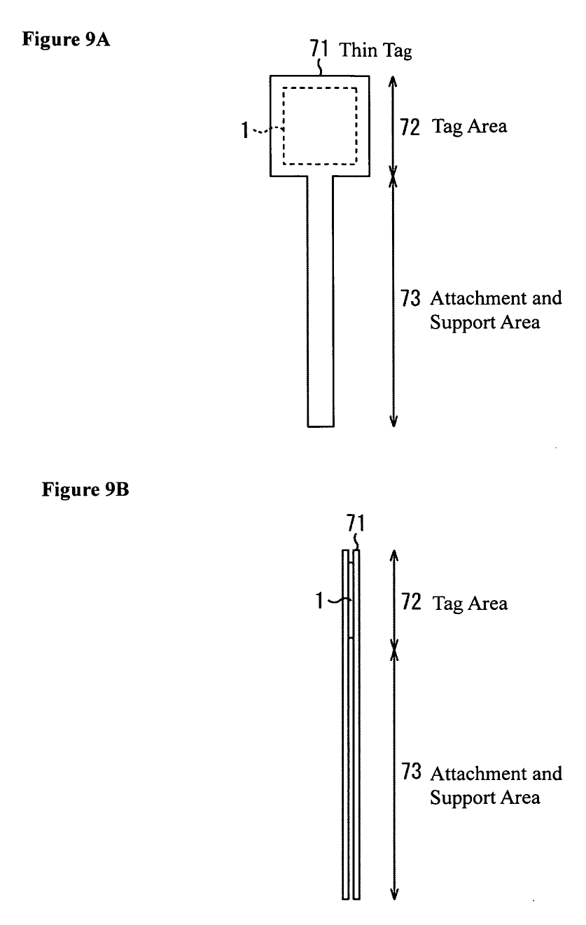

A container (for example, the object (milk pack) of FIG. 19) with an attached identification tag (for example thin tag 71 of FIG. 9) according to claim 8, includes a communication means (for example wireless IC tag 1 of FIG. 1) to communicate information related to the container in a non-contact manner, and an isolation means (for example, tag area 72 and attachment and support area 73 shown in FIG. 9) by which isolation between the container and the communication means is provided in the tangential direction with respect to the surface of the container, while the communication means is supported on one lengthwise end of the isolation means, and the object is attached or connected on another lengthwise end of the isolation means.

Below embodiments appropriate to these inventions will be described in detail with reference to the figures. In these embodiments the size of wireless IC tag 1 is approximately 10 mm square, but other sizes of tags, larger or smaller may be used as well.

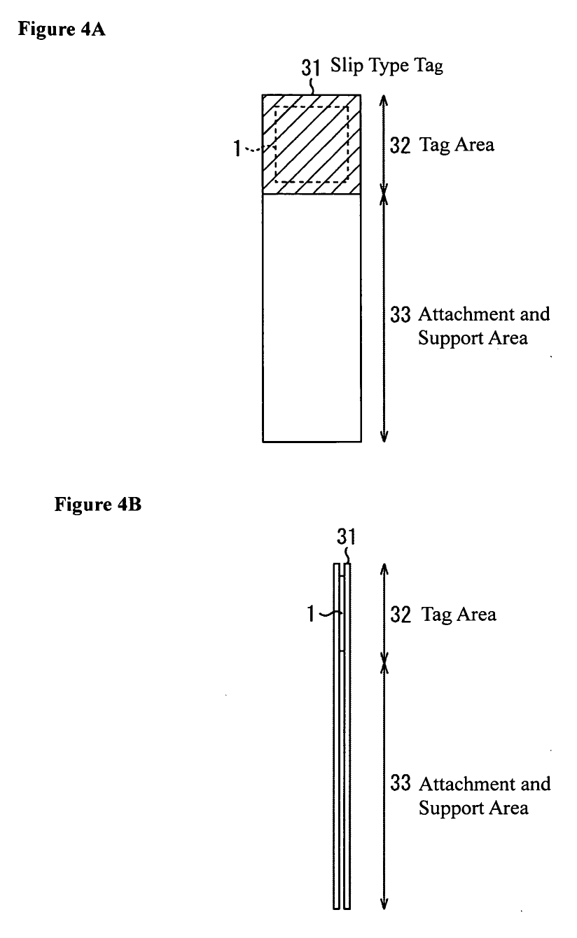

FIG. 4 shows external views of a first embodiment of a slip type tag 31 according to this invention. FIG. 4A is a front view, and 4B is a sectional view.

The structure of this slip type tag 31 is such that thin rectangular sheets of paper or plastic sandwich the wireless IC tag 1 between them, and even if it is bent in the lengthwise direction, it can recover its original shape. The area where thin plate IC tag 1 is sandwiched shall be called tag area 32, while the remaining area shall be called an attachment and support area 33.

The tag area 32 is of a different color than the attachment and support area 33 to facilitate distinguishing the two in order that when one approaches manually with a communications device, it will be easy to visually confirm the position where the wireless IC tag is sandwiched inside. The attachment and support area 33 may be affixed to object 2 by means of paste, glue, clips, pins, etc. Additionally, it could be inserted into object 2 such as to secure some distance between object 2 and wireless IC tag 1. The length of attachment and support area 33 should be set with consideration given to the interference properties of object 2, be it metal or contain aqueous material, but normally it should be several cm long (5 cm for example).

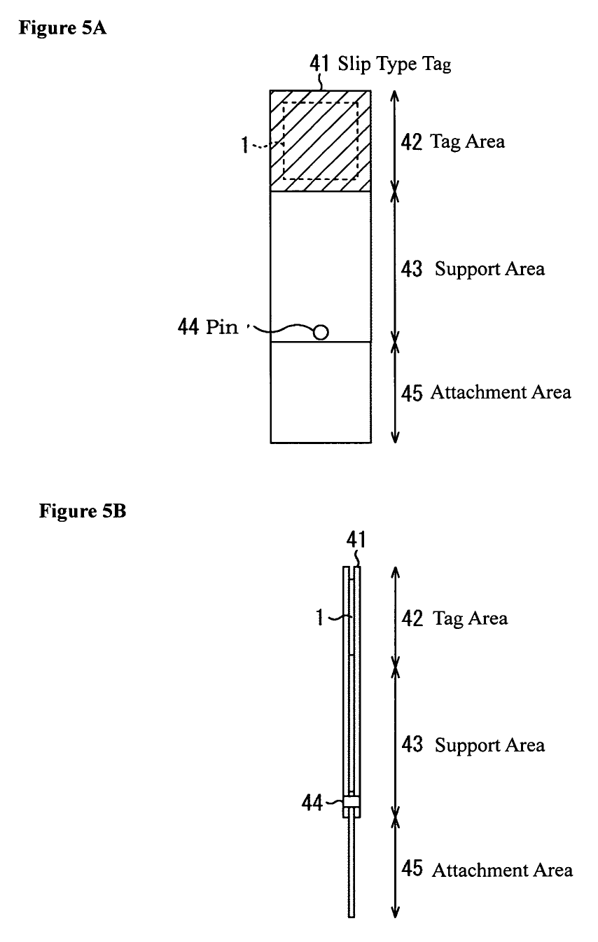

FIG. 5 shows external views of a second embodiment of a slip type tag 41 according to the present invention. FIG. 5A is a front view, FIG. 5B a sectional view.

The structure of this slip type tag 41 is such that wireless IC tag 1 is sandwiched between thin rectangular strips of paper or plastic, which even when bent in the lengthwise direction, will return to their original shape. The area where the thin wireless IC tag 1 is sandwiched shall be called tag area 42, while the other areas shall be referred to as support area 43.

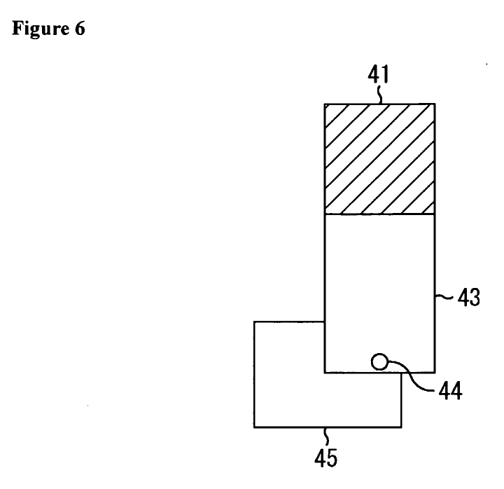

Tag area 42, where wireless IC tag 1 is sandwiched, is of a different color than support area 43 to allow for clear visual discrimination of its position. Support area 43 is designed to secure distance between object 2 and wireless IC tag 1. The end opposite the foregoing thin slip tag area 42 is attachment area 45 which is inserted and supported in a manner that allows it to freely rotate around pin 44. As shown in FIG. 6, for example, attachment area 45 can retain the tag area 42 and support area 43 at any desired angle. Attachment area 45 is attached to object 2 by paste, glue, clips, pins, etc., or, it may be inserted into the object.

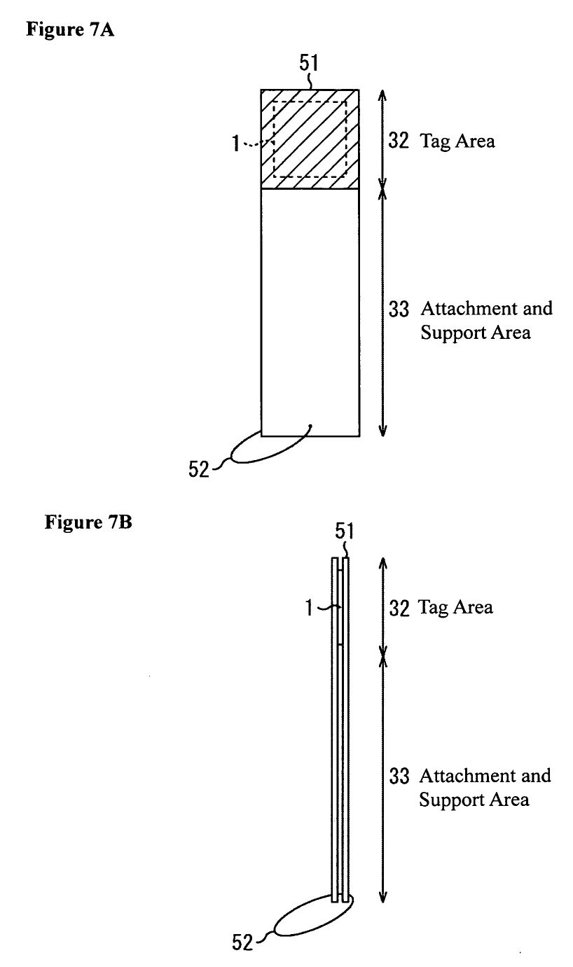

FIG. 7 shows external views of slip type tag 51 as a third embodiment of the present invention. FIG. 7A is a front view, FIG. 7B a sectional view.

This slip type tag 51 may be secured with attachment band 52, comprising for example, a ring shaped rubber band, to the end of attachment and support area 33 of slip type tag 31. The remainder of the structure is identical to and bears the same reference numbers as that described for slip type tag 31. By employing an attachment band 52, it is possible to attach slip type tag 31 to objects 2 of any desired shape that have an irregular surface (for example, to plastic bottles).

FIG. 8 shows external views of a fourth embodiment of a slip type tag 61 according to this invention. FIG. 8A is a front view, FIG. 8B a sectional view.

With this slip type tag 61, attachment band 62 comprising a ring-shaped elastic material such as a rubber band has been added to the attachment area 45 end of the slip type tag 41 shown in FIG. 5. The remainder of the structure is identical to and bears the same reference numbers as described for slip type tag 41. By employing an attachment band 62, it is possible to attach slip type tag 51 to objects 2 of any desired shape that have an irregular surface.

FIG. 9 shows external views of thin tag 71 as a fifth embodiment of the present invention. FIG. 9A is a front view, FIG. 9B a sectional view.

The structure of this thin tag 71 employs thin strips of paper or plastic to sandwich wireless IC tag 2 between them, which when bent in the lengthwise direction, can recover their original shape. The area where wireless IC tag 1 is sandwiched between the thin strips shall be called tag area 72 and the other area, shall be called attachment and support area 73.

The width of attachment and support area 73 is less than the width of tag area 72. Accordingly, a user can quickly discern the position where wireless IC tag 1 is located. It would be further possible to make tag area 72 a different color from attachment and support area 73. Attachment and support area 73 may be affixed to object 2 using paste, glue, clips, pins, etc., or it may be directly inserted to secure some distance between object 2 and wireless IC tag 1.

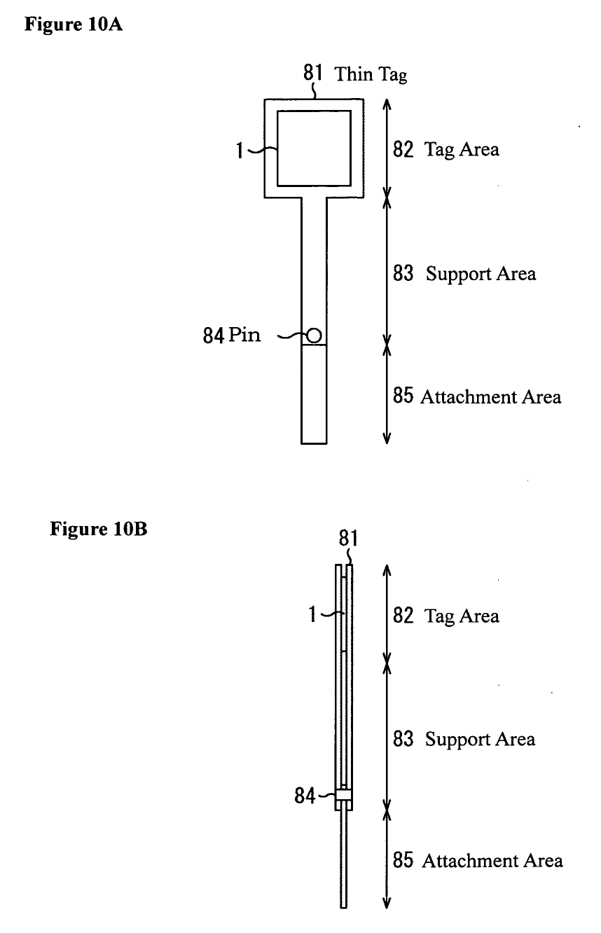

FIG. 10 shows external views of a thin tag 81 as a sixth embodiment of the present invention. FIG. 10A is a front view, FIG. 10B a sectional view.

The structure of thin tag 81, has wireless IC tag 1 sandwiched between thin strips of paper or plastic, which bent in the lengthwise direction, will return to its original shape. Tag area 81 is that area where wireless IC tag 1 is sandwiched within, while the remaining area of the tag shall be called support area 83.

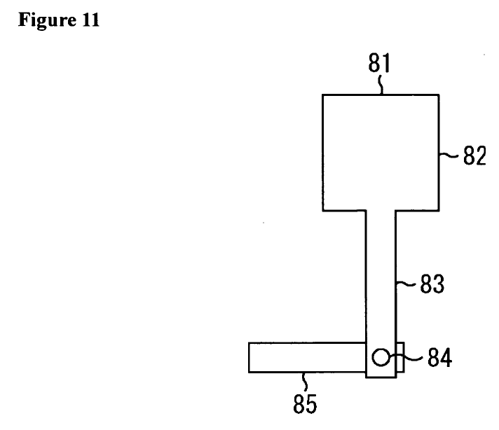

The width of attachment and support area 83 is narrower than the width of tag area 82. Accordingly, a user can readily identify the position where wireless IC tag 1 is sandwiched within. It would further be possible to distinguish tag area 82 from support area 83 by color. Support area 83 serves to secure some distance between object 2 and wireless IC tag 1. On the end opposite from the aforementioned thin strip tag area 82 is attachment area 85, which is held by pin 84 and is free to rotate around its axis. Attachment area 85, as shown for example in FIG. 11, allows tag area 82 and support area 83 to be held at any desired angle. Attachment area 85 may be attached to object 2 using paste, adhesives, clips, pins, etc, or it may be directly inserted into object 2.

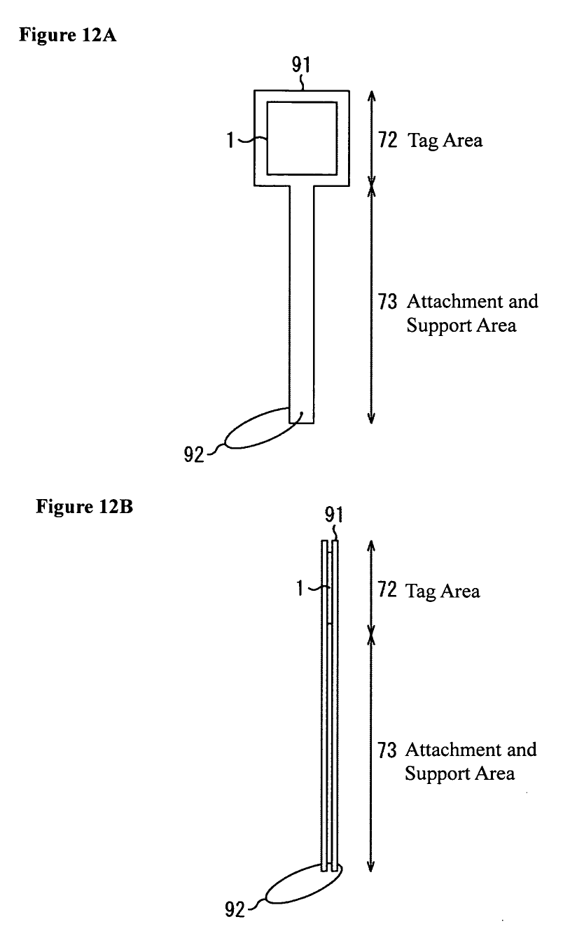

FIG. 12 shows external views of thin tag 91 as a seventh embodiment of the present invention. FIG. 12A is a front view, FIG. 12B a sectional view.

The present thin tag 91, has an attachment band 92 made of a ring shaped elastic material such as a rubber band as attachment and support area 73, as an addition to thin tag 71's attachment and support area 73 shown in FIG. 9. The remainder of the structure is similar to that of thin tag 71 and as such bears the same reference numbers. Equipping thin tag 91 with attachment band 92 allows it to be attached to objects 2 of any desired shape with an irregular surface.

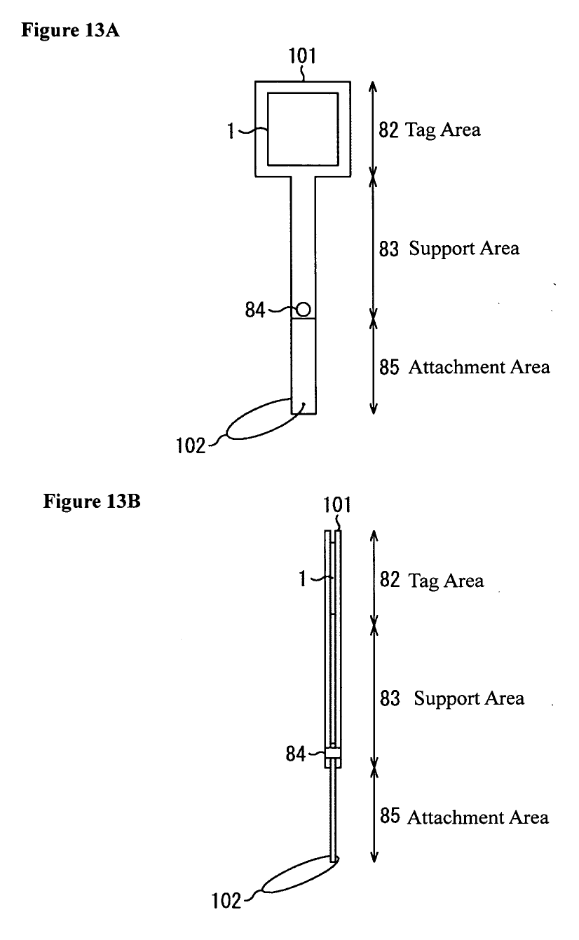

FIG. 13 shows external views of thin tag 101 as an eighth embodiment of the present invention. FIG. 13A is a front view, FIG. 13B a sectional view.

The present thin tag 101 has an attachment band 102 comprised of a ring shaped elastic material such as a rubber band added to the attachment area 85 of thin tag 81 shown in FIG. 10. The remainder of the structure is similar to that of thin tag 71 and as such bears the same reference numbers. Equipping thin tag 101 with attachment band 102 allows it to be attached to objects 2 of any desired shape with an irregular surface

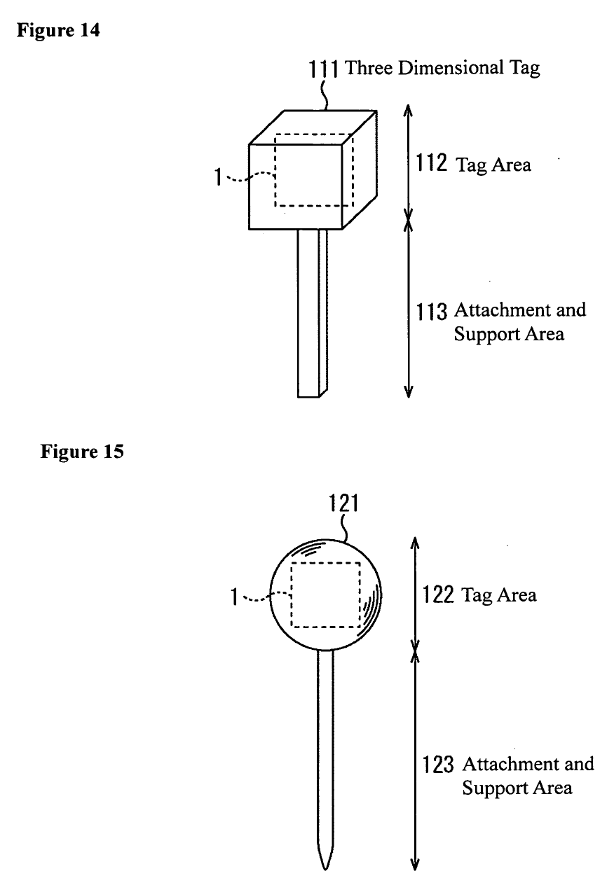

FIG. 14 shows an external view of a three dimensional tag 111 as a ninth embodiment of the present invention. The present three dimensional tag 111 employs a three dimensional object as tag area 112 made of plastic, etc. which contains wireless IC tag 1, with tag area 112 supported on one end by attachment and support area 113 at the other end, where it attaches to object 2.

The thickness of the three dimensional tag area 112 is, for example, approximately 1 cm or greater. By making the tag area 112 three dimensional, even if other three dimensional tags 111 are positioned nearby, the thickness of the material separates the internal wireless IC tags 1 from each other to thereby inhibit any occurrence of miscommunications or other problems.

Further, making tag area 112 three dimensional makes it easy for the user to readily confirm the location of the internal wireless IC tag 1. It would be further possible to distinguish tag area 112 from attachment and support area 113 by color.

The material used for attachment and support area 113 may be, for example, paper, plastic, wood, etc, and it may be attached to object 2 by paste, adhesives, clips, pins, etc, or it may be directly inserted into object 2 in a manner such that some distance is secured between object 2 and wireless IC tag 1. The length of attachment and support area 113 should be set with consideration given as to whether object 2 has aqueous content or made of metal, but usually it should be several centimeters (approximately 5 cm) long.

FIG. 15 shows an external view of a marker pin type tag 121 as a tenth embodiment of the present invention. In this marker pin type tag 121, a plastic, etc., sphere contains wireless IC tag 1 in tag area 122. Tag area 122 is supported at one end by attachment and support area 123, which attaches to object 2 at the other end.

Since tag area 122 is spherical rather than comprised of thin strips, even if it were adjacent to other marker pin type tags 121, the thickness of the sphere serves to separate the internal wireless IC tags from each other. Accordingly, this prevents any occurrence of miscommunication and the like arising from the wireless IC tags 1 being too close to each other.

Further, since tag area 122 is a sphere, a user can readily determine the location of wireless IC tag 1 contained therein. It would be further possible to distinguish tag area 122 from attachment and support area 123 by color.

Materials such as paper, plastic, wood, etc. may be used to form attachment and support area 123, and then it may be attached by paste, adhesives, clips, pins, etc to object 2, or it may be directly inserted into object 2 in a manner such that some distance is secured between object 2 and wireless IC tag 1. The length of attachment and support area 123 should take into consideration of the interference from any metal or aqueous content in object 2, but normally should be several centimeters (for example approximately 5 cm).

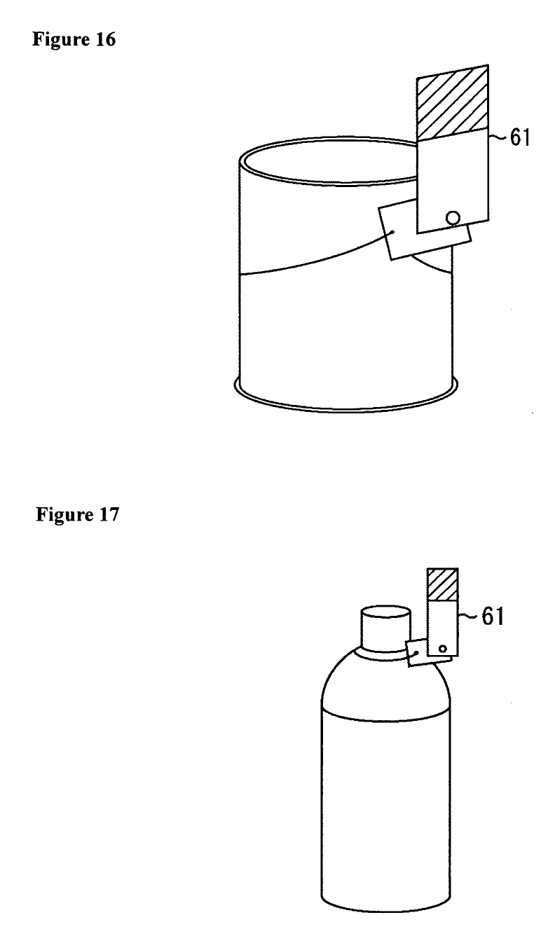

FIGS. 16 and 17 show examples of the attachment view of slip type tags 61 to object 2.

Because slip type tag 61 is equipped with attachment band 62, it can be attached to cylindrical cans such as shown in FIG. 16, or onto objects 2 of any desired shapes such as the liquid-holding plastic bottle shown in FIG. 17. Further, since it is very easy to remove such slip type tags 61, it is possible to prevent the disclosure of information they contain or to reuse them again after removal. These same characteristics apply to slip type tag 51 and thin tags 91 and 101.

Further, slip type tag 61 makes it possible to separate wireless IC tag 1 from object 2 by a distance equivalent to the length of support area 43 from object 2. Therefore, should object 2 be a metal can such as shown in FIG. 16, or even a plastic bottle filled with liquid as shown in FIG. 17, electromagnetic communication between wireless IC tag 1 and communication device 3 can be conducted without interference. Slip type tags 31, 41, 51; thin tags 71, 81, 91, 101; three dimensional tags 111, and marker pin type tags 121 also share these characteristics.

Further, since it is possible to establish the desired angle between the attachment area 45 and support area 43 on slip type tag 61, tag area 42, which holds wireless IC tag 1, can be set at an angle that facilitates communications with communications device 3. Also, while not in use, the tag can be rotated back upon itself around pin 44 to effectively conserve space while in storage. Slip type tags 41, 51, thin tags 81, and 101 also share these characteristics.

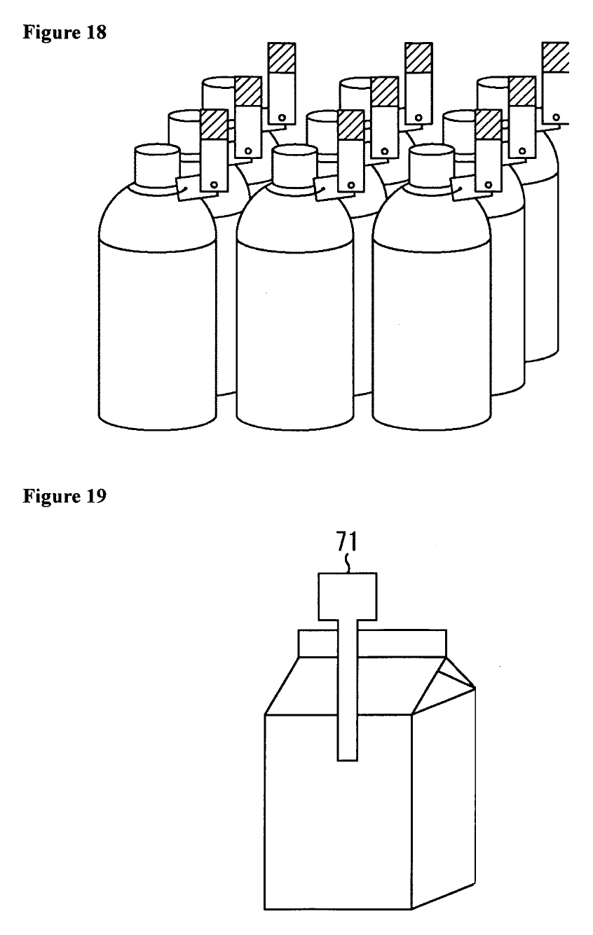

As is apparent from the foregoing explanation, utilizing the characteristics of slip type tag 61, for example to manage a plurality of objects such as shown in FIG. 18, it is simple to project the tags from object 2 and orient them in the same direction, to thereby facilitate the reading operation in which the information from a plurality of the slip type tags 61 can be read all at one time.

Also, as shown in FIG. 19 for example, if containers are manufactured with a tag such as thin tag 71 attached by adhesive (for example, paper pack milk cartons and the like), at the time of manufacture of the container, wireless IC tag 1 can be utilized all the way from the filling process (with milk, etc.) through the retail sales of the product. Further, if the adhesive surface is relatively narrower such as with a thin type tag 71, then when sold to the consumer, thin tag 71 may be easily removed to prevent disclosure of the information on the tag or to allow the reuse of wireless IC tag 1.

1. An Identification tag for attaching to an object, comprising:
a communication means to communicate information related to the object in a non-contact manner; and
an isolation means by which isolation between the object and said communication means is provided in the tangential direction with respect to the surface of the object, while said communication means is supported on one lengthwise end of said isolation means, and the object is attached or connected on another lengthwise end of said isolation means.

2. The Identification tag according to claim 1, wherein said isolation means comprises:
a support means to support said communications means; and
an attachment means to attach said communications means to the object.

3. The Identification tag according to claim 2, wherein said support means and said attachment means of said isolation means are made distinguishable from each other either by color or shape.

4. The Identification tag according to claim 2, wherein said isolation means further comprises a rotary support means to connect said support means and said attachment means so that said support means is adjustable at any desired angle as an axis to which the attachment means can be attached.

5. The Identification tag according to claim 2, wherein said isolation means further comprises a ring-shaped elastic member.

6. The Identification tag according to claim 2, wherein said isolation means is made from material that can recover its original shape after being bent.

7. A method of attaching an Identification tag to an object, comprising the step of isolating a communication means from an object in the tangential direction with respect to the surface of the object by an isolation means, while said isolation means supports said communication means on one lengthwise end of said isolation means, and supports the object on another lengthwise end of said isolation means.

8. A container with an attached identification tag, comprises:
a communication means to communicate information related to the container in a non-contact manner; and
an isolation means by which isolation between the container and said communication means is provided in the tangential direction with respect to the surface of the container, while said communication means is supported on one lengthwise end of said isolation means, and the object is attached or connected on another lengthwise end of said isolation means
